(19) United States
(12) Patent Application Publication
(10) Pub. No.: US 2021/0070448 A1
(43) Pub. Date: Mar. 11, 2021

(54) AIRCRAFT PARTITIONS HAVING AN ELECTROCHROMIC DISPLAY, AND RELATED METHODS

(71) Applicant: The Boeing Company, Chicago, IL (US)

(72) Inventors: Nha Thanh Nguyen, Shoreline, WA (US); Sopheap Ya, Renton, WA (US)

(21) Appl. No.: 16/565,175

(22) Filed: Sep. 9, 2019

(51) Int. Cl. B64D 11/00; G02F 1/157

(52) U.S. Cl. CPC B64D 11/0023; G02F 1/157

(57) ABSTRACT

Aircraft partitions include a body panel and a partition mounting portion that selectively and removably couples the body panel to an aircraft passenger cabin. The body panel may indicate a transition between a first section of an aircraft passenger cabin and a second section of the aircraft passenger cabin, and at least a portion of the body panel may be an electrochromic region that comprises an electrochromic material. The electrochromic region may have a selectively adjustable transparency and/or may display information and/or entertainment to passengers. Aircraft may include such an aircraft partition and an aircraft mounting portion for selectively and removably coupling the aircraft partition to the aircraft passenger cabin via the partition mounting portion. Methods of reconfiguring an aircraft passenger cabin may include removing a first aircraft partition from a first aircraft mounting portion of the aircraft passenger cabin and installing a second aircraft partition at the first aircraft mounting portion.

### FIELD

The present disclosure relates generally to aircraft partitions, and more particularly to aircraft partitions having an electrochromic display, and related methods.

### BACKGROUND

Passenger airlines often divide aircraft into two or more different passenger sections within the aircraft cabin. For example, an aircraft passenger cabin may include an economy section that is differentiated from a first class or business class section, such as by including different sizes of seats and/or offering different amenities. Often, the transitions between these different passenger sections are indicated by one or more dividers (also referred to as partitions), monuments, and/or curtains positioned within the aircraft cabin. These dividers and monuments can offer privacy between different passenger sections, though conventional dividers are fixedly mounted within the aircraft, and thus are not configured to be moved, interchanged, or otherwise adjusted. Monitors throughout the aircraft cabin may be used to display video and information to passengers, though airlines are limited in the size of monitors that can be incorporated into aircraft cabins due to weight restrictions.

### SUMMARY

The present disclosure concerns multi-purpose removable aircraft partitions that may be interchanged with one another and/or moved to different areas of a given aircraft. Such partitions also include an electrochromic material such that they may function as a smart display, may have a selectively changeable transparency level, and/or may incorporate the in-flight entertainment system.

One example of a presently disclosed aircraft partition includes a body panel and a partition mounting portion that selectively and removably couples the body panel to the aircraft passenger cabin. The body panel is configured to indicate a transition between a first section of an aircraft passenger cabin and a second section of the aircraft passenger cabin, and at least a portion of the body panel is an electrochromic region that comprises an electrochromic material. Disclosed aircraft may include such an aircraft partition and an aircraft mounting portion for selectively and removably coupling the aircraft partition to the aircraft passenger cabin via the partition mounting portion of the aircraft partition. The aircraft mounting portion may be configured to supply power to the electrochromic region via an aircraft power source.

In another example, a passenger aircraft includes a first passenger section, a second passenger section, and a monument positioned to indicate a transition between the first passenger section and the second passenger section. The monument may include a body panel having a first side and a second side, wherein the second side is opposite the first side, wherein the first side faces the first passenger section, and wherein the second side faces the second passenger section. At least a portion of the body panel may be an electrochromic region that comprises an electrochromic material, with the electrochromic region forming a transparent video display.

Related methods also are disclosed. For example, a method of reconfiguring an aircraft passenger cabin may include removing a first aircraft partition from a first aircraft mounting portion of the aircraft passenger cabin and installing a second aircraft partition at the first aircraft mounting portion.

### BRIEF DESCRIPTION OF THE DRAWINGS

FIG. 1 is a perspective view of an aircraft which may include one or more presently disclosed aircraft partitions.

FIG. 2 is a schematic, black-box representation of presently disclosed aircraft partitions.

FIG. 3 is a schematic representation of the various layers of a presently disclosed aircraft partition.

FIG. 4 is a schematic representation of network connections to a presently disclosed aircraft partition in an aircraft.

FIG. 5 is a perspective view of a portion of an interior cabin of an aircraft that includes presently disclosed aircraft partitions.

FIG. 6 is an elevation view of an example of a presently disclosed aircraft partition.

FIG. 7 is a perspective view of an example of a presently disclosed aircraft partition.

FIG. 8 is a schematic flowchart diagram of methods according to the present disclosure.

### DESCRIPTION

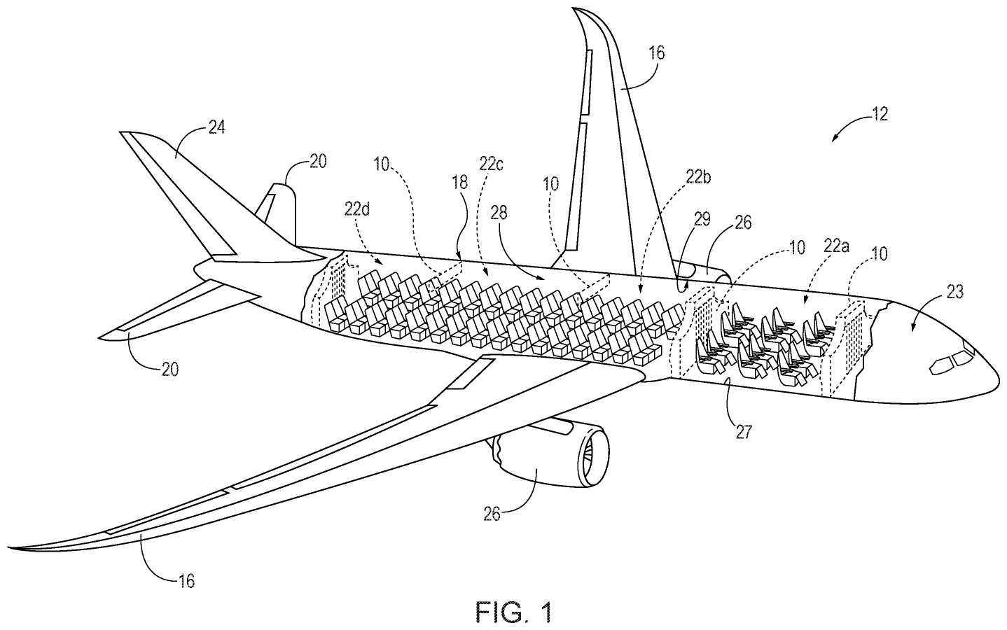

With reference to FIG. 1, one or more aircraft partitions 10 may be included in an aircraft 12. In FIG. 1, an example of aircraft 12 that may include one or more aircraft partitions 10 generally is illustrated in the form of a passenger aircraft. Aircraft 12 may take any suitable form, including commercial aircraft, military aircraft, or any other suitable aircraft. Aircraft 12 generally includes wings 16, fuselage 18, horizontal stabilizers 20, vertical stabilizers 24, and engine housings 26. While FIG. 1 illustrates aircraft 12 in the form of a fixed wing aircraft, other types and configurations of aircraft are within the scope of aircraft 12 according to the present disclosure, including (but not limited to) rotorcraft and helicopters. While aircraft partitions 10 are described in the context of use within passenger aircraft (e.g., aircraft 12), disclosed aircraft partitions 10 may be included in other structures or vehicles, such as in space satellites, transit vehicles, shipping containers, public transportation vehicles, marine vessels, buses, passenger trains, shelters, and/or other assemblies or structures.

Aircraft 12 may include one or more aircraft partitions 10 positioned with an interior cabin 28 (also referred to herein as an aircraft passenger cabin 28). Such aircraft partitions 10 may be positioned to indicate a transition between two sections 22 of interior cabin 28. For example, an aircraft partition 10 may be positioned between a cockpit 23 and a first section 22a of interior cabin 28, between first section 22a and a second section 22b of interior cabin 28, between second section 22b and a third section 22c of interior cabin 28, and/or between third section 22c and a fourth section 22d of interior cabin 28. Of course, other examples of aircraft 12 may include more or fewer sections 22 of interior cabin 28. Additionally or alternatively, aircraft 12 may include more or fewer aircraft partitions 10 than shown, and/or a given section 22 may include more or fewer aircraft partitions 10 than shown. Aircraft partitions 10 may be sized and shaped to increase privacy between respective sections 22 (e.g., between first section 22a and second section 22b). Respective sections 22 of interior cabin 28 may represent different seat class sections (e.g., first section 22a may be a business class or first class section, while second section 22b may be an economy class section or a main cabin section), though in other examples, one or more sections 22 may be the same or similar types of class sections. In some examples, aircraft partitions 10 may be configured to replace one or more overhead monitors in interior cabin 28. Aircraft partitions 10 may be installed such that they are secured to the walls, ceilings, and/or overhead stow bins within interior cabin 28 of aircraft 12. Additionally or alternatively, disclosed aircraft partitions 10 may take the form of an aircraft monument, which may extend substantially from a cabin floor 27 to a cabin ceiling 29 within interior cabin 28.

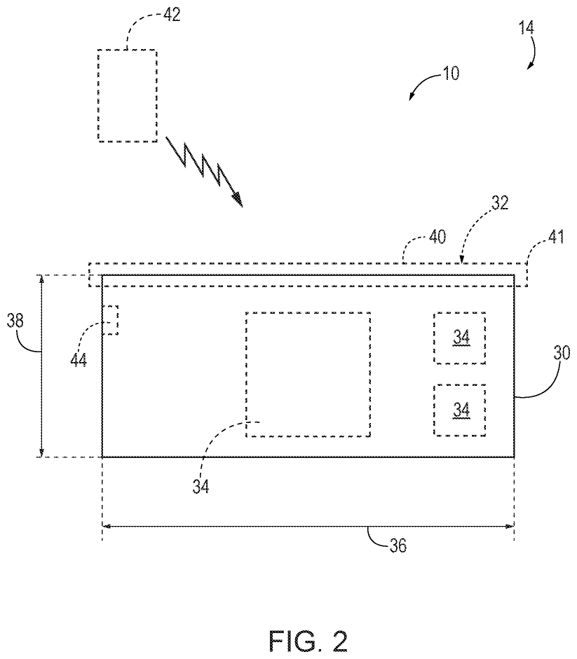

FIGS. 2-4 provide illustrative, non-exclusive examples of aircraft partitions 10 and/or systems 14 including such aircraft partitions 10 according to the present disclosure. In general, elements that are likely to be included in a given (i.e., a particular) example are illustrated in solid lines, while elements that are optional to a given example are illustrated in dashed lines. However, elements that are shown in solid lines are not essential to all examples, and an element shown in solid lines may be omitted from a given example without departing from the scope of the present disclosure.

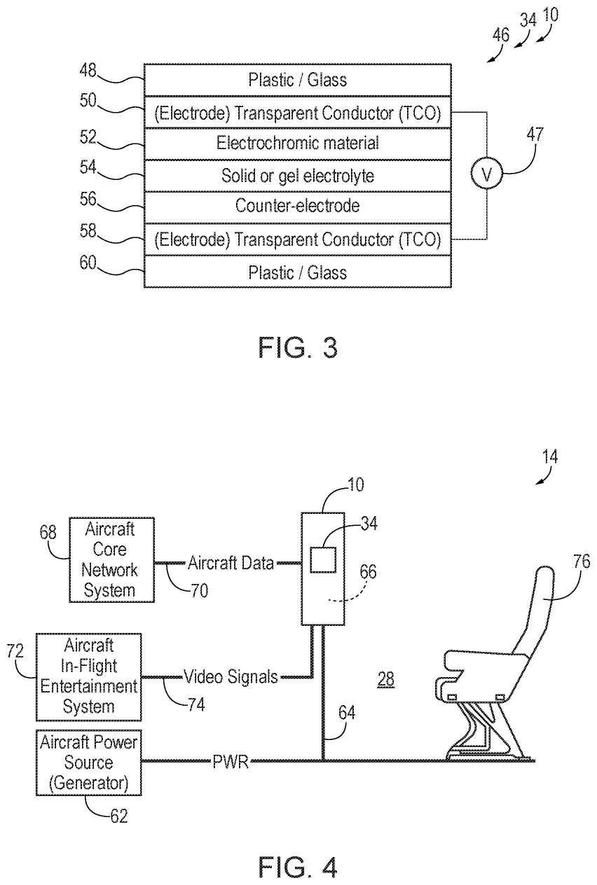

As shown in FIG. 2, aircraft partition 10 includes a body panel 30 and a partition mounting portion 32, with at least a portion of body panel 30 being an electrochromic region 34 that is formed of an electrochromic material that is configured to change colors due to the application of a voltage 47 (FIG. 3). When aircraft partition 10 is installed in an aircraft (e.g., aircraft 12), body panel 30 is configured to indicate a transition between one section of the aircraft passenger cabin (e.g., first section 22a of interior cabin 28) and another section of the aircraft passenger cabin (e.g., second section 22b of interior cabin 28). Partition mounting portion 32 is configured to selectively and removably couple body panel 30 to the interior cabin 28. For example, partition mounting portion 32 may be configured such that aircraft partition 10 is selectively manually and/or electronically removable from interior cabin 28 by disengaging partition mounting portion 32 from interior cabin 28. Aircraft partition 10 further is selectively manually and/or electronically replaceable in interior cabin 28 by engaging partition mounting portion 32 with interior cabin 28 in the same or a different location within interior cabin 28.

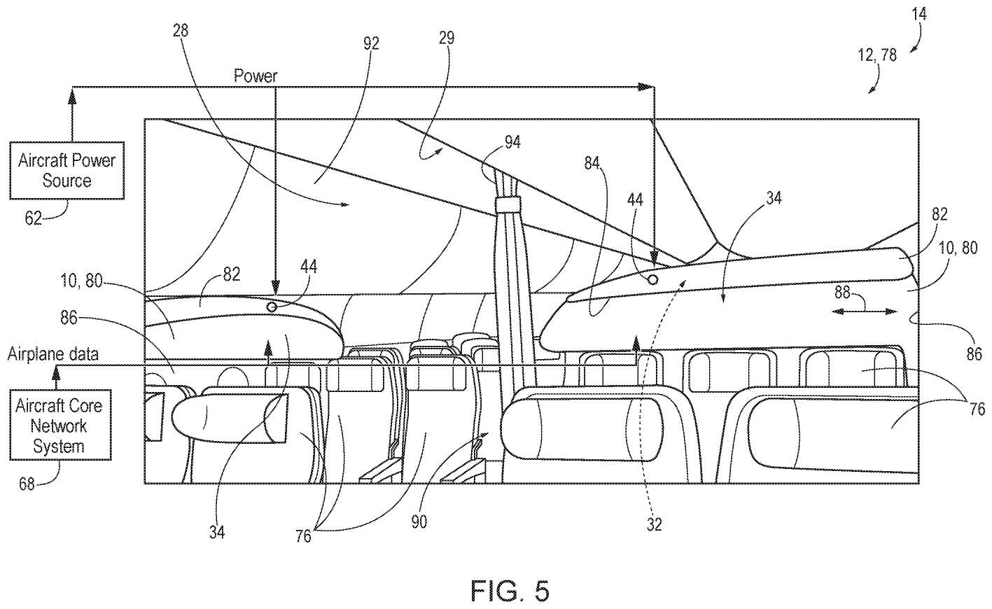

Partition mounting portion 32 may extend along substantially the entirety of a length 36 of aircraft partition 10 in some examples. In other examples, partition mounting portion 32 may extend along only a portion of length 36 of aircraft partition 10. Additionally or alternatively, partition mounting portion 32 may be positioned along some or all of a height 38 of aircraft partition 10. In some examples, partition mounting portion 32 may be configured to slide into an aircraft mounting portion (e.g., aircraft mounting portion 82 of FIG. 5) coupled to the aircraft passenger cabin to couple aircraft partition 10 to the aircraft passenger cabin. For example, partition mounting portion 32 may include a partition groove 40 configured to receive a structure of the aircraft mounting portion in order to couple aircraft partition 10 to the aircraft passenger cabin. In other examples, the aircraft mounting portion may include a mounting groove (e.g., aircraft mounting groove 84 of FIG. 5) configured to receive partition mounting portion 32 of aircraft partition 10. Other suitable structures for partition mounting portion 32 will be apparent to those of ordinary skill in the art. Partition mounting portion 32 may include a locking mechanism 41 configured to lock body panel 30 to the aircraft passenger cabin when locking mechanism 41 is engaged. Presently disclosed aircraft partitions 10 may be configured to be installed in an aircraft (e.g., via partition mounting portion 32) at the time of aircraft production and/or as a retrofit.

In some examples, electrochromic region 34 may be a majority of the surface area of body panel 30. In other examples, electrochromic region 34 may be formed over a minority of the surface area of body panel 30. As a specific example, substantially all of the surface area of body panel 30 may form electrochromic region 34. In some examples, body panel 30 includes a plurality of electrochromic regions 34, which may be spaced apart from each other, may be adjacent one another, may overlap with one another, may be sized and shaped substantially identically to one another, and/or one or more respective electrochromic regions 34 may be differently sized and/or shaped from one or more other respective electrochromic regions 34. Electrochromic region 34 may be integrally formed with body panel 30 in some examples of aircraft partition 10, or coupled to body panel 30 in other examples.

Electrochromic region 34 may be a transparent video display. Additionally or alternatively, electrochromic region 34 may be configured to be selectively transitioned between an opaque configuration (wherein the electrochromic region is substantially opaque) and a transparent configuration (wherein the electrochromic region is substantially transparent). For example, electrochromic region 34 may be transitioned between such configurations at various phases of a given flight, such as by being in the transparent configuration during takeoff and landing, and in the opaque configuration during the flight between takeoff and landing. Of course, electrochromic region 34 may be selectively transitioned at any desired time during, before, and/or after the flight. In some examples, electrochromic region 34 has a selectively variable degree of transparency, and may be selectively transitioned between, for example, around 0% transparency, at least 10% transparency, at least 20% transparency, at least 30% transparency, at least 40% transparency, at least 50% transparency, at least 60% transparency, at least 70% transparency, at least 80% transparency, at least 90% transparency, and/or 100% transparency. Electrochromic region 34 is configured to be automatically substantially transparent, or at least partially transparent, when electrochromic region 34 is not powered, in some examples. Additionally or alternatively, electrochromic region 34 may be configured to impart a frosted and/or translucent appearance.

Additionally or alternatively, electrochromic region 34 may be configured to display video, flight information (e.g., flight path, current latitude/longitude, flight duration, etc.), destination information (e.g., temperature at the destination, distance and/or time remaining to destination, etc.), flight status, flight phases, advertisements, connecting flight information, branding artwork, crew announcements, and/or entertainment. In some examples, flight data may be streamed to electrochromic region 34. In this manner, aircraft partition 10 may be configured to serve multiple purposes, such as in providing privacy and indicating transitions between sections of an aircraft passenger cabin, providing aircraft brand differentiation, and also providing a way to display visual content and video to passengers on board the aircraft. Electrochromic region 34 may have a pitch designed to optimize viewing by passengers in the interior cabin of the aircraft in which the aircraft partition 10 is installed. In some examples, electrochromic region 34 may be configured to automatically change information displayed by electrochromic region 34 based on flight status and/or external input. For example, system 14 may include a controller 42 configured to provide said external input to control electrochromic region 34, and/or aircraft partition 10 may include an input device 44 configured to allow a user to selectively control electrochromic region 34. Controller 42 and/or input device 44 may be configured to selectively change the degree of transparency of electrochromic region 34. Additionally or alternatively, controller 42 and/or input device 44 may be configured to change the information displayed by electrochromic region 34. For example, controller 42 and/or input device 44 maybe used to cause electrochromic region 34 to display safety information before a flight, to be transparent during takeoff, and then to display entertainment (e.g., a movie) during the flight. As will be appreciated by one of ordinary skill in the art, controller 42 and/or input device 44 may take any suitable form, including but not limited to knobs, dials, slide adjustments, switches, buttons, etc.

In examples of aircraft partition 10 including more than one electrochromic region 34, controller 42 and/or input device 44 may be configured to control all of the electrochromic regions 34 independently, controller 42 and/or input device 44 may be configured to control all of the electrochromic regions 34 together, and/or each respective electrochromic region 34 may have its own respective controller 42 and/or input device 44. In examples where aircraft 12 includes a plurality of aircraft partitions 10, controller 42 may be configured to control all or some of the plurality of electrochromic regions 34 of all or some of the aircraft partitions 10. In other examples of aircraft 12 including a plurality of aircraft partitions 10, system 14 may include a plurality of controllers 42, such as by including a respective controller 42 for each respective aircraft partition 10.

Aircraft partitions 10 may be formed of any suitable materials, with said materials generally being selected to be lightweight and/or to provide customizable design choices. In some examples, aircraft partitions 10 may be formed of polycarbonate and/or composite materials, though other materials are within the scope of the present disclosure.

As shown in FIG. 3, electrochromic region 34 may be formed of a laminate 46 having a plurality of layers. For example, electrochromic region 34 may include a first polymer layer 48, a first transparent conductor layer 50 (which also may be referred to as a first electrode layer 50), an electrochromic material layer 52, an electrolyte layer 54, a counter-electrode layer 56, a second transparent conductor layer 58 (which also may be referred to as a second electrode layer 58), and/or a second polymer layer 60. First polymer layer 48 and second polymer layer 60 are generally transparent layers, though in some examples may be only partially transparent. In alternative examples, first polymer layer 48 and/or second polymer layer 60 may be formed of glass (e.g., a transparent glass such as silica) rather than of polymeric materials. Electrolyte layer 54 may be a solid or gel electrolyte. Voltage 47 applied across first electrode layer 50 and second electrode layer 58 causes changes in appearance of electrochromic material layer 52 such that the transparency of and/or a visual display on electrochromic region 34 may be changed and controlled. For example, first electrode layer 50 and second electrode layer 58 may in turn push (or pull) ions from counter-electrode layer 56, through electrolyte layer 54 and into electrochromic material layer 52 (or vice versa). In some examples, applying a sufficiently high voltage will push a sufficient concentration of ions into electrochromic material layer 52 to deactivate electrochromic material layer 52, leaving it substantially transparent. Additionally or alternatively, electrochromic material layer 52 may be configured to be transparent when not powered. In some examples, varying applied voltage 47 may correspondingly change the concentration of ions in electrochromic material layer 52. Depending on the electrochromic material (or materials) used in electrochromic material layer 52, different parts of the spectrum may be blocked under various voltage conditions, thereby changing the appearance and/or display provided by electrochromic region 34.

Electrochromic region 34 generally is powered by a power supply on board the aircraft in which the aircraft partition 10 is installed (e.g., an onboard aircraft power supply generally provides voltage 47). For example, as shown in FIG. 4, electrochromic region 34 may be operatively coupled to an aircraft power source 62 such that it receives power 64 from said aircraft power source 62. Additionally or alternatively, electrochromic region 34 may include a battery 66 or other power source that is independent of aircraft power source 62 to supply voltage 47. Additionally or alternatively, electrochromic region 34 may be operatively coupled to a core network system 68 of aircraft 12 in which aircraft partition 10 is installed. In this manner, aircraft data 70 may be provided to electrochromic region 34, such as altitude, location, flight duration, and/or other data. Additionally or alternatively, electrochromic region 34 may be operatively coupled to an in-flight entertainment system 72 on board the aircraft in which aircraft partition 10 is installed. In this manner, video signals 74 may be sent to electrochromic region 34 such that passengers may view in-flight entertainment (e.g., movies and television shows) on electrochromic region 34.

FIG. 4 also shows an example of a passenger seat 76 that may be positioned within interior cabin 28 of aircraft 12. As mentioned previously, electrochromic region 34 may be oriented and positioned to optimize viewing by passengers seated in such a passenger seat 76. Additionally or alternatively, aircraft partition 10 may be customized for a particular seat geometry within interior cabin 28 and/or to meet head injury criterion requirements on board aircraft 12. For example, aircraft partition 10 and/or electrochromic region 34 may be sized and/or shaped to fit around one or more passenger seats 76 in an aesthetically pleasing way. As another example, aircraft partitions 10 and/or electrochromic regions 34 may be sized and shaped according to the size and shape of passenger seats 76 in a given section 22 of interior cabin 28. For example, a respective section 22 having larger passenger seats 76 (e.g., a first class or business class section) may also include larger aircraft partitions 10 and/or respectively larger electrochromic regions 34, whereas a respective section 22 having smaller passenger seats 76 (e.g., an economy class section) may include smaller aircraft partitions 10 and/or respectively smaller electrochromic regions 34. Additionally, aircraft partitions 10 may be sized and shaped so as not to interfere with overhead storage bins in interior cabin 28.

FIGS. 5-7 provide illustrative, non-exclusive examples of aircraft partitions 10 according to the present disclosure. Where appropriate, the reference numerals from the schematic illustrations of FIGS. 1-4 are used to designate corresponding parts of the examples of FIGS. 5-7; however, the examples of FIGS. 5-7 are non-exclusive and do not limit aircraft partitions 10 to the illustrated examples of FIGS. 5-7. That is, aircraft partitions 10 are not limited to the specific illustrated examples of an aircraft partition 80, an aircraft monument 100, and an aircraft monument 110, and aircraft partitions 10 may incorporate any number of the various aspects, configurations, characteristics, properties, etc. that are illustrated in and discussed with reference to the schematic representations of FIGS. 1-4 and/or the examples of FIGS. 5-7, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to each of the examples of FIGS. 5-7; however, it is within the scope of the present disclosure that the previously discussed features, variants, etc. may be utilized therewith.

FIG. 5 illustrates a portion of an example of interior cabin 28 of an aircraft 78 (which is an example of aircraft 12), which includes a plurality of passenger seats 76 and a plurality of aircraft partitions 80 (with each aircraft partition 80 being an example of aircraft partition 10). Aircraft 78 includes an aircraft mounting portion 82 for each aircraft partition 80, with each respective aircraft mounting portion 82 selectively and removably coupling a respective aircraft partition 80 to aircraft 78, within interior cabin 28. In one example, aircraft mounting portions 82 each include an aircraft mounting groove 84 for receiving a respective aircraft partition 80. For example, partition mounting portion 32 of aircraft partition 80 may be configured to slide into aircraft mounting groove 84 (e.g., towards a side wall 86 of interior cabin 28) to engage aircraft partition 80 with aircraft mounting portion 82, thereby securing aircraft partition 80 into place within interior cabin 28. Similarly, partition mounting portion 32 of aircraft partition 80 may be configured to slide out of aircraft mounting groove 84 (e.g., away from side wall 86, towards an aisle 90 of interior cabin 28) to disengage aircraft partition 80 from aircraft mounting portion 82, thereby enabling selective removal of aircraft partition 80. In some examples, aircraft partition 80 may be slid into and out of aircraft mounting groove 84 in a direction substantially normal to side wall 86 of interior cabin 28 (e.g., in the directions indicated by arrow 88).

As shown in FIG. 5, aircraft partitions 80 may be positioned above passenger seats 76 (e.g., between passenger seats 76 and an overhead stow bin 92), in some examples. Aircraft mounting portions 82 may be coupled to overhead stow bins 92, side wall 86, and/or cabin ceiling 29 of interior cabin 28. Additionally or alternatively, aircraft mounting portions 82 may be configured to supply power 64 to aircraft partition 80 (e.g., to electrochromic region 34 of aircraft partition 80). Also as shown in FIG. 5, systems 14 additionally may include one or more relocatable curtains 94.

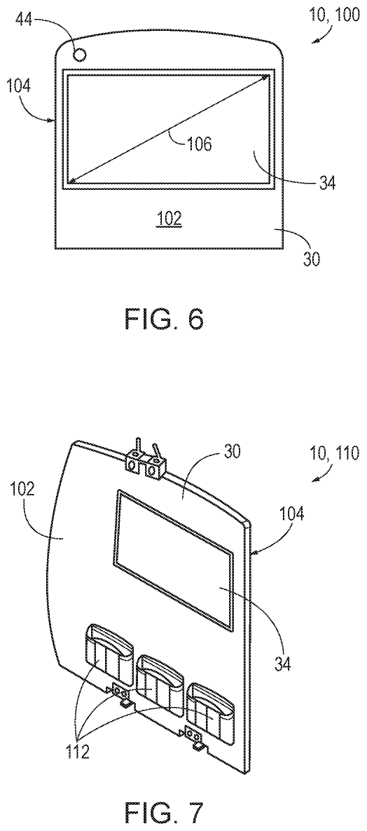

FIG. 6 illustrates another example of aircraft partition 10, in the form of aircraft monument 100. Aircraft monument 100 includes body panel 30 and electrochromic region 34. Body panel 30 may be defined by a first side 102 that faces passengers, and a second side 104 opposite first side 102. Aircraft monument 100 may be positioned within an interior cabin of a passenger aircraft such that it indicates a transition between one passenger section and another passenger section within the interior cabin. In the example shown in FIG. 6, electrochromic region 34 is sized such that it consumes a majority of the surface area, or footprint, of body panel 30, though in other examples, electrochromic region 34 may be relatively smaller with respect to the size of body panel 30, and in some examples may consume less than a majority of the surface area of body panel 30. In absolute terms, a diagonal dimension 106 of electrochromic region 34 may be at least 30 inches, at least 32 inches, at least 34 inches, at least 36 inches, at least 38 inches, at least 40 inches, at least 42 inches, at least 44 inches, at least 46 inches, at least 48 inches, and/or at least 50 inches. The use of electrochromic regions 34 in aircraft monuments 100 (and in other examples of aircraft partitions 10) to display video and/or other information to passengers on board the passenger aircraft may enable the passenger aircraft to include larger video displays than previously acceptable due to weight constraints. Such electrochromic regions 34 included with disclosed monuments 100 (and other examples of aircraft partitions 10) may be configured to replace overhead and/or seatback monitors included in some passenger aircraft.

Electrochromic region 34 may be coupled to body panel 30 of aircraft monument 100, or may be integrally formed with body panel 30. As with other examples, electrochromic region 34 of aircraft monument 100 may have a selectively variable degree of transparency. For example, electrochromic region 34 may be configured to be selectively transitioned between an opaque configuration (in which electrochromic region 34 is at least substantially opaque) and a transparent configuration (in which electrochromic region 34 is at least substantially transparent) via the application of voltage to electrochromic region 34. Electrochromic region 34 may display video, flight information, destination information, flight status, advertisements, branding artwork, crew announcements, and/or entertainment to passengers and/or crew on board to the aircraft, as discussed in more detail herein.

FIG. 7 illustrates aircraft monument 110, which is another example of aircraft partition 10. Similar to aircraft monument 100 of FIG. 6, aircraft monument 110 includes body panel 30 and electrochromic region 34, though in the example of aircraft monument 110, electrochromic region 34 consumes a smaller proportion of the surface area of body panel 30. As shown in FIG. 7, aircraft monument 110 may include one or more receptacles 112 (e.g., magazine holders) for containing and storing informational sheets, magazines, and/or other personal items for passengers during a flight. Disclosed aircraft partitions 10, as shown in the example of aircraft monument 110 in FIG. 7, may be configured such that electrochromic region 34 does not extend all the way down to the bottom of aircraft partition 10. In some examples, electrochromic region 34 may extend to a comfortable viewing area for seated passengers.

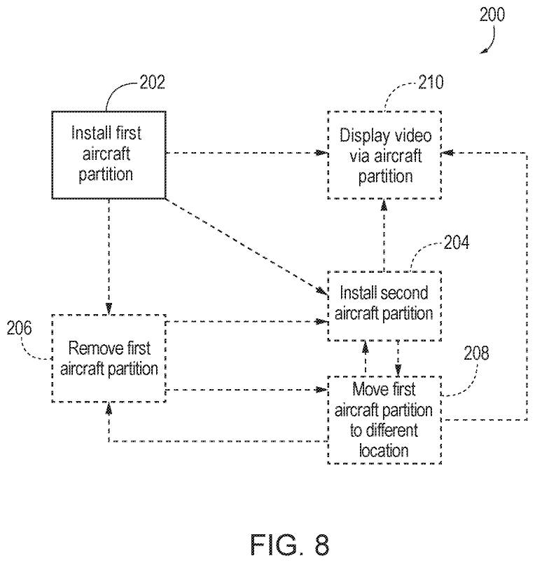

FIG. 8 schematically provides a flowchart that represents illustrative, non-exclusive examples of methods 200 according to the present disclosure. In FIG. 8, some steps are illustrated in dashed boxes indicating that such steps may be optional or may correspond to an optional version of a method according to the present disclosure. That said, not all methods 200 according to the present disclosure are required to include the steps illustrated in solid boxes. The methods and steps illustrated in FIG. 8 are not limiting and other methods and steps are within the scope of the present disclosure, including methods having greater than or fewer than the number of steps illustrated, as understood from the discussions herein.

Methods 200 of reconfiguring an aircraft passenger cabin (e.g., aircraft passenger cabin 28) of an aircraft (e.g., aircraft 12) generally include installing a first aircraft partition (e.g., aircraft partition 10) within the aircraft passenger cabin, at 202. As described above, installing the first aircraft partition at 202 may be performed at the time of manufacture of the aircraft, or as a retrofit within a previously manufactured aircraft. In a representative example, installing the first aircraft partition at 202 may include sliding a partition mounting portion (e.g., partition mounting portion 32) of the first aircraft partition into an aircraft mounting portion (e.g., aircraft mounting portion 82) within the aircraft. In other examples, other mechanisms and motions may be utilized to secure the aircraft partition with respect to the aircraft passenger cabin. For example, installing the first aircraft partition at 202 may include snapping or clicking the aircraft partition into place within the aircraft mounting portion, engaging interlocking components on the aircraft partition and the aircraft mounting portion, engaging a spring-biased component on the aircraft partition and/or the aircraft mounting portion, and/or securing the aircraft partition via one or more selectively removable fasteners.

One or more additional aircraft partitions (e.g., a second aircraft partition 10) may be installed within the aircraft passenger cabin at 204. For example, a given aircraft may include a plurality of aircraft mounting portions within the aircraft passenger cabin, with each respective aircraft mounting portion being configured to receive and/or engage a respective aircraft partition according to the present disclosure. In some examples, one or more aircraft partitions may be removed from the aircraft passenger cabin at 206. Once an aircraft partition is removed at 206 (e.g., by disengaging the aircraft partition from the aircraft mounting portion), the second aircraft partition may be installed at 204 in the location where the first aircraft partition was removed, and/or the removed aircraft partition may be moved to a different location within the same or a different aircraft, at 208. In this manner, aircraft partitions may be reconfigured (switched out, interchanged, moved, etc.) on a given aircraft without needing to take the aircraft out of service, due to the selectively removable and interchangeable nature of presently disclosed aircraft partitions. Video and/or information may be displayed via the electrochromic region of each aircraft partition, at 210, as described previously herein.

Illustrative, non-exclusive examples of inventive subject matter according to the present disclosure are described in the following enumerated paragraphs:

A1. An aircraft partition for an aircraft, the aircraft partition comprising:

a body panel configured to indicate a transition between a first section of an aircraft passenger cabin and a second section of the aircraft passenger cabin, wherein at least a portion of the body panel is an electrochromic region that comprises an electrochromic material; and

a partition mounting portion that selectively and removably couples the body panel to the aircraft passenger cabin.

A2. The aircraft partition of paragraph A1, wherein the partition mounting portion is configured such that the aircraft partition is selectively manually removable from the aircraft passenger cabin by disengaging the partition mounting portion from the aircraft passenger cabin, and wherein the aircraft partition further is selectively manually replaceable in the aircraft passenger cabin by engaging the partition mounting portion with the aircraft passenger cabin.

A3. The aircraft partition of any of paragraphs A1-A2, wherein the partition mounting portion is configured such that the aircraft partition is selectively electronically removable from the aircraft passenger cabin by electrically disengaging the partition mounting portion from the aircraft passenger cabin, and wherein the aircraft partition further is selectively electronically replaceable in the aircraft passenger cabin by electrically engaging the partition mounting portion with the aircraft passenger cabin.

A4. The aircraft partition of any of paragraphs A1-A3, wherein the partition mounting portion comprises a partition groove configured to receive an aircraft mounting portion coupled to the aircraft passenger cabin, thereby coupling the aircraft partition to the aircraft passenger cabin.

A5. The aircraft partition of any of paragraphs A1-A4, wherein the partition mounting portion is configured to slide into a/the aircraft mounting portion coupled to the aircraft passenger cabin, thereby coupling the aircraft partition to the aircraft passenger cabin.

A6. The aircraft partition of any of paragraphs A1-A5, wherein the electrochromic region comprises a majority of a surface area of the body panel.

A7. The aircraft partition of any of paragraphs A1-A6, wherein the electrochromic region comprises substantially all of a/the surface area of the body panel.

A8. The aircraft partition of any of paragraphs A1-A7, wherein the electrochromic region is coupled to the body panel.

A9. The aircraft partition of any of paragraphs A1-A8, wherein the electrochromic region is integrally formed with the body panel.

A10. The aircraft partition of any of paragraphs A1-A9, wherein the electrochromic region comprises a transparent video display.

A11. The aircraft partition of any of paragraphs A1-A10, wherein the electrochromic region is configured to be selectively transitioned between an opaque configuration and a transparent configuration, wherein the electrochromic region is substantially opaque in the opaque configuration, and wherein the electrochromic region is substantially transparent in the transparent configuration.

A12. The aircraft partition of any of paragraphs A1-A11, wherein the electrochromic region has a selectively variable degree of transparency.

A13. The aircraft partition of any of paragraphs A1-A12, wherein the electrochromic region is configured to display flight information, destination information, flight status, flight phases, advertisements, branding artwork, crew announcements, and/or entertainment.

A14. The aircraft partition of any of paragraphs A1-A13, wherein the electrochromic region is configured to display video.

A15. The aircraft partition of any of paragraphs A1-A14, wherein the electrochromic region is configured to automatically change information displayed by the electrochromic region based on flight status and/or external input.

A16. The aircraft partition of any of paragraphs A1-A15, further comprising a controller configured to control the electrochromic region.

A17. The aircraft partition of any of paragraphs A1-A16, further comprising an input device configured to selectively change a/the degree of transparency of the electrochromic region.

A18. The aircraft partition of any of paragraphs A1-A17, wherein the aircraft partition is configured to increase privacy between the first section of the aircraft passenger cabin and the second section of the aircraft passenger cabin.

A19. The aircraft partition of any of paragraphs A1-A18, wherein the aircraft partition is configured to replace overhead monitors in the aircraft passenger cabin.

A20. The aircraft partition of any of paragraphs A1-A19, wherein the electrochromic region has a pitch to optimize viewing by passengers in the aircraft passenger cabin.

A21. The aircraft partition of any of paragraphs A1-A20, wherein the aircraft partition is customized for a particular seat geometry within the aircraft passenger cabin.

A22. The aircraft partition of any of paragraphs A1-A21, wherein the electrochromic region is configured to be powered by a power supply on board the aircraft.

A23. The aircraft partition of any of paragraphs A1-A22, wherein the electrochromic region is configured to connect to a core network system of the aircraft.

A24. The aircraft partition of any of paragraphs A1-A23, wherein the partition mounting portion comprises a locking mechanism configured to lock the body panel to the aircraft passenger cabin when the locking mechanism is engaged.

A25. The aircraft partition of any of paragraphs A1-A24, wherein the electrochromic region comprises a laminate of a plurality of layers.

A26. The aircraft partition of any of paragraphs A1-A25, wherein the electrochromic region comprises a first polymer layer, a first transparent conductor layer, an electrochromic layer, an electrolyte layer, a counter-electrode layer, a second transparent conductor layer, and/or a second polymer layer.

A27. The aircraft partition of any of paragraphs A1-A26, wherein the electrochromic region comprises an/the electrolyte layer, and wherein the electrolyte layer is a solid or gel electrolyte layer.

A28. The aircraft partition of any of paragraphs A1-A27, wherein the electrochromic region comprises a first transparent material, a first electrode, an ion storage layer, an electrolyte layer, an electrochromic layer, a second electrode, and a second transparent material.

A29. The aircraft partition of paragraph A28, wherein the first transparent material and the second transparent material comprise a transparent glass.

A30. The aircraft partition of paragraph A29, wherein the transparent glass comprises silica.

A31. The aircraft partition of any of paragraphs A1-A30, wherein the electrochromic region is configured to be at least substantially transparent when the electrochromic region is not powered.

A32. The aircraft partition of any of paragraphs A1-A31, wherein the aircraft partition is configured to be installed in the aircraft at production.

A33. The aircraft partition of any of paragraphs A1-A32, wherein the aircraft partition is configured to be installed in the aircraft as a retrofit.

A34. The aircraft partition of any of paragraphs A1-A33, wherein the aircraft partition is an aircraft monument.

B1. An aircraft monument for a passenger aircraft, wherein the aircraft monument is positioned to indicate a transition between a first passenger section of the passenger aircraft and a second passenger section of the passenger aircraft, wherein the aircraft monument comprises a body panel having a first side and a second side, wherein the second side is opposite the first side, wherein the first side faces the first passenger section, wherein the second side faces the second passenger section, and wherein at least a portion of the body panel is an electrochromic region that comprises an electrochromic material.

B2. The aircraft monument of paragraph B1, wherein the electrochromic region comprises a majority of a surface area of the body panel.

B3. The aircraft monument of any of paragraphs B1-B2, wherein the electrochromic region has a diagonal dimension of greater than 42 inches.

B4. The aircraft monument of any of paragraphs B1-B3, wherein the electrochromic region is coupled to the body panel.

B5. The aircraft monument of any of paragraphs B1-B4, wherein the electrochromic region is integrally formed with the body panel.

B6. The aircraft monument of any of paragraphs B1-B5, wherein the electrochromic region comprises a transparent video display.

B7. The aircraft monument of any of paragraphs B1-B6, wherein the electrochromic region is configured to be selectively transitioned between an opaque configuration and a transparent configuration, wherein the electrochromic region is substantially opaque in the opaque configuration, and wherein the electrochromic region is substantially transparent in the transparent configuration.

B8. The aircraft monument of any of paragraphs B1-B7, wherein the electrochromic region has a selectively variable degree of transparency.

B9. The aircraft monument of any of paragraphs B1-B8, wherein the electrochromic region is configured to display flight information, destination information, flight status, advertisements, branding artwork, crew announcements, and/or entertainment.

B10. The aircraft monument of any of paragraphs B1-B9, wherein the electrochromic region is configured to display video.

B11. The aircraft monument of any of paragraphs B1-610, wherein the electrochromic region is configured automatically change information displayed by the electrochromic region based on flight status and/or external input.

B12. The aircraft monument of any of paragraphs B1-B11, further comprising a controller configured to control the electrochromic region.

B13. The aircraft monument of any of paragraphs B1-B12, further comprising an input device configured to selectively change a/the degree of transparency of the electrochromic region.

B14. The aircraft monument of any of paragraphs B1-B13, wherein the electrochromic region is configured to be powered by a power supply on board the aircraft.

B15. The aircraft monument of any of paragraphs B1-B14, wherein the electrochromic region is configured to connect to a core network system of the aircraft.

B16. The aircraft monument of any of paragraphs B1-B15, wherein the electrochromic region comprises a laminate of a plurality of layers.

B17. The aircraft monument of any of paragraphs B1-B16, wherein the electrochromic region comprises a first polymer layer, a first transparent conductor layer, an electrochromic layer, an electrolyte layer, a counter-electrode layer, a second transparent conductor layer, and/or a second polymer layer.

B18. The aircraft monument of any of paragraphs B1-B17, wherein the electrochromic region comprises an/the electrolyte layer, and wherein the electrolyte layer is a solid or gel electrolyte layer.

B19. The aircraft monument of any of paragraphs B1-B18, wherein the electrochromic region comprises a first transparent material, a first electrode, an ion storage layer, an electrolyte layer, an electrochromic layer, a second electrode, and a second transparent material.

B20. The aircraft monument of paragraph B19, wherein the first transparent material and the second transparent material comprise a transparent glass.

B21. The aircraft monument of paragraph B20, wherein the transparent glass comprises silica.

C1. An aircraft comprising the aircraft partition of any of paragraphs A1-A33 and/or the aircraft monument of any of paragraphs B1-B21.

C2. The aircraft of paragraph C1, further comprising an/the aircraft mounting portion for selectively and removably coupling the aircraft partition to the aircraft passenger cabin via the partition mounting portion of the aircraft partition.

C3. The aircraft of paragraph C2, wherein the aircraft mounting portion comprises blade mount grooves.

C4. The aircraft of any of paragraphs C2-C3, wherein the aircraft mounting portion is configured to supply power to the electrochromic region via an/the aircraft power source.

C5. The aircraft of any of paragraphs C1-C4, further comprising one or more selectively relocatable curtains.

C6. The aircraft of any of paragraphs C1-05, comprising a/the first passenger section and a/the second passenger section.

D1. A method of reconfiguring an aircraft passenger cabin, the method comprising:

removing a first aircraft partition from a first aircraft mounting portion of the aircraft passenger cabin, wherein the first aircraft partition is the aircraft partition of any of paragraphs A1-A33.

D2. The method of paragraph D1, further comprising moving the first aircraft partition and installing the first aircraft partition at a second aircraft mounting portion of the aircraft passenger cabin.

D3. The method of paragraph D1, further comprising installing a second aircraft partition at the first aircraft mounting portion, wherein the second aircraft partition is the aircraft partition of any of paragraphs A1-A33.

D4. The method of any of paragraphs D1-D3, further comprising displaying video via a first electrochromic region and/or a second electrochromic region.

E1. The use of an electrochromic material in an aircraft partition and/or an aircraft monument.

E2. The use of the aircraft partition of any of paragraphs A1-A33 to convey video and/or information to airline passengers.

E3. The use of the aircraft monument of any of paragraphs B1-B21 to convey video and/or information to airline passengers.

As used herein, the terms “selective” and “selectively,” when modifying an action, movement, configuration, or other activity of one or more components or characteristics of an apparatus, mean that the specific action, movement, configuration, or other activity is a direct or indirect result of user manipulation of an aspect of, or one or more components of, the apparatus.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one example, to at least one, optionally including more than one, A, with no B present (and optionally including entities other than B); in another example, to at least one, optionally including more than one, B, with no A present (and optionally including entities other than A); in yet another example, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” may mean A alone, B alone, C alone, A and B together, A and C together, B and C together, or A, B, and C together, and optionally any of the above in combination with at least one other entity.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

As used herein, the phrase, “for example,” the phrase, “as an example,” and/or simply the term “example,” when used with reference to one or more components, features, details, structures, examples, and/or methods according to the present disclosure, are intended to convey that the described component, feature, detail, structure, example, and/or method is an illustrative, non-exclusive example of components, features, details, structures, examples, and/or methods according to the present disclosure. Thus, the described component, feature, detail, structure, example, and/or method is not intended to be limiting, required, or exclusive/exhaustive; and other components, features, details, structures, examples, and/or methods, including structurally and/or functionally similar and/or equivalent components, features, details, structures, examples, and/or methods, are also within the scope of the present disclosure.

1. An aircraft partition for an aircraft, the aircraft partition comprising:
a body panel configured to indicate a transition between a first section of an aircraft passenger cabin and a second section of the aircraft passenger cabin, wherein at least a portion of the body panel is an electrochromic region that comprises an electrochromic material; and
a partition mounting portion that selectively and removably couples the body panel to the aircraft passenger cabin.

2. The aircraft partition according to claim 1, wherein the partition mounting portion is configured such that the aircraft partition is selectively manually removable from the aircraft passenger cabin by disengaging the partition mounting portion from the aircraft passenger cabin, and wherein the aircraft partition further is selectively manually replaceable in the aircraft passenger cabin by engaging the partition mounting portion with the aircraft passenger cabin.

3. The aircraft partition according to claim 1, wherein the electrochromic region comprises a majority of a surface area of the body panel.

4. The aircraft partition according to claim 1, wherein the electrochromic region comprises a transparent video display.

5. The aircraft partition according to claim 1, wherein the electrochromic region is configured to be selectively transitioned between an opaque configuration and a transparent configuration, wherein the electrochromic region is substantially opaque in the opaque configuration, and wherein the electrochromic region is substantially transparent in the transparent configuration.

6. The aircraft partition according to claim 1, wherein the electrochromic region has a selectively variable degree of transparency.

7. The aircraft partition according to claim 1, further comprising a controller configured to control the electrochromic region by selectively controlling content displayed by the electrochromic region.

8. The aircraft partition according to claim 7, wherein the electrochromic region is configured to display at least one selected from the group consisting of flight information, destination information, flight status, advertisements, branding artwork, crew announcements, and entertainment.

9. The aircraft partition according to claim 1, wherein the electrochromic region is configured to automatically change information displayed by the electrochromic region based on flight status and/or phases.

10. The aircraft partition according to claim 1, further comprising an input device configured to selectively change a degree of transparency of the electrochromic region.

11. The aircraft partition according to claim 1, wherein the aircraft partition is customized for a particular seat geometry within the aircraft passenger cabin.

12. The aircraft partition according to claim 1, wherein the electrochromic region is configured to be powered by a power supply on board the aircraft.

13. The aircraft partition according to claim 1, wherein the electrochromic region is configured to connect to a core network system of the aircraft.

14. The aircraft partition according to claim 1, wherein the partition mounting portion comprises a locking mechanism configured to lock the body panel to the aircraft passenger cabin when the locking mechanism is engaged.

15. The aircraft partition according to claim 1, wherein the electrochromic region is configured to be at least substantially transparent when the electrochromic region is not powered.

16. A passenger aircraft, comprising:
the aircraft partition according to claim 1; and
an aircraft mounting portion for selectively and removably coupling the aircraft partition to the aircraft passenger cabin via the partition mounting portion of the aircraft partition, wherein the aircraft mounting portion is configured to supply power to the electrochromic region via an aircraft power source.

17. A passenger aircraft, comprising:
a first passenger section;
a second passenger section; and
a monument positioned to indicate a transition between the first passenger section and the second passenger section, wherein the monument comprises a body panel having a first side and a second side, wherein the second side is opposite the first side, wherein the first side faces the first passenger section, wherein the second side faces the second passenger section, wherein at least a portion of the body panel is an electrochromic region that comprises an electrochromic material, and wherein the electrochromic region comprises a transparent video display.

18. The passenger aircraft according to claim 17, wherein the electrochromic region is configured to be selectively transitioned between an opaque configuration and a transparent configuration, wherein the electrochromic region is substantially opaque in the opaque configuration, and wherein the electrochromic region is substantially transparent in the transparent configuration.

19. A method of reconfiguring an aircraft passenger cabin, the method comprising:
removing a first aircraft partition from a first aircraft mounting portion of the aircraft passenger cabin, wherein the first aircraft partition comprises:
a first body panel configured to indicate a transition between a first section of the aircraft passenger cabin and a second section of the aircraft passenger cabin, wherein at least a portion of the first body panel is a first electrochromic region that comprises a first electrochromic material; and
a first partition mounting portion that selectively and removably couples the first body panel to the aircraft passenger cabin; and
installing a second aircraft partition at the first aircraft mounting portion, wherein the second aircraft partition comprises:
a second body panel configured to indicate the transition between the first section of the aircraft passenger cabin and the second section of the aircraft passenger cabin, wherein at least a portion of the second body panel is a second electrochromic region that comprises a second electrochromic material; and
a second partition mounting portion that selectively and removably couples the second body panel to the aircraft passenger cabin.

20. The method according to claim 19, further comprising displaying video via the second electrochromic region.
